(19) United States
(12) Patent Application Publication
(10) Pub. No.: US 2004/0071190 A1
(43) Pub. Date: Apr. 15, 2004

(54) Temperature probe and thermometer having the same

(76) Inventor: Hsiao-Yi Chang, Tall City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/274,220

(22) Filed: Oct. 18, 2002

(30) Foreign Application Priority Data
Oct. 11, 2002 (TW) 91216096

(51) Int. Cl. G01K 7/00

(52) U.S. Cl. 374/185; 374/208

(57) ABSTRACT

A temperature probe for use in a medical thermometer. The temperature probe includes a probe body and a hollow tip member secured to the probe body. The hollow tip member further has a thermal contact surface. The thermal sensor is mounted on the inside of the thermal contact surface so as to sense the temperature of the thermal contact surface and produce a temperature signal. Wires are connected to the thermal sensor to pass the temperature signal. Specifically, each of the wires have at least a portion bonded to the inside of the thermal contact surface, thereby allowing the wires to reach thermal equilibrium quickly.

### BACKGROUND OF THE INVENTION

1. Field of the Invention

The invention relates to the field of thermometers. More particularly, the invention relates to the field of medical thermometers employing a temperature probe for measurement of a patient's temperature, although it is equally applicable to other temperature measurement fields

2. Description of the Related Art

As disclosed in U.S. Pat. No. 4,183,248, electronic thermometers offer a great number of advantages over conventional glass and mercury thermometer for use in the health care field. Among the advantages of electronic thermometers are the elimination of sterilization procedure for glass thermometers, a digital temperature display to eliminate temperature reading errors, and higher accuracy and resolution, e.g., 1/10 degree Fahrenheit, being easily attainable with proper circuit design and calibration.

However, the major concern with regard to the electronic thermometers lays on their slow time response. This problem is incurred mainly because a thermometer probe represents a certain amount of mass and heat capacity, and when inserted from room temperature into a body cavity it cannot change temperature instantaneously, but instead approaches its final temperature more or less exponentially. It often requires over three minutes lag time before a final stabilized temperature is measured.

For the purpose of time response reduction, prior art techniques have included using a thermometer probe that has a metal tip for higher heat conductance. Additionally, U.S. Pat. No. 4,183,248 discloses an electronic thermometer which comprises two temperature sensors and a heater coil. The heater coil is used to thermally isolate the tip from the remainder of the probe, which eliminates long thermal time delays. The patent claims that a remarkable improvement of about 16 seconds measurement time is accomplished. U.S. Pat. No. 5,632,555 employs a heater to bring the probe tip to a specific temperature before it is applied to a patient. A microprocessor using a prediction algorithm is provided to determine the final temperature. This patent claims a measurement time of approximately 4 to 15 seconds. Nevertheless, these thermometers have some drawbacks such as high circuit complexity, high energy consumption and high production cost, since they have a built-in heater and/or expensive microprocessor.

To overcomes the aforementioned problems, U.S. Pat. No. 6,419,388 discloses an electronic medical thermometer which comprises a probe body having a metal tip to contact with a patient's tissue. The metal tip has a conical nose portion. The tip includes a temperature sensor mounted within the conical nose portion. The sensor thus generates a signal representing the temperature of the metal tip. Notably, the ratio of the metal tip's length to the metal tip's diameter is 3:1 at least. U.S. Pat. No. 6,419,388 claims that such a metal tip provides a small thermal capacity and a function like thermal isolation. This results in a measurement time of 20 to 30 seconds without a heater. However, transmission wires for the temperature signal, as shown in U.S. Pat. No. 6,419,388, are not fixed within the metal tip and exposed to air or gas such that the wires form a heat flow path which cannot be neglected. As a result, this takes the considerable measurement time.

### SUMMARY OF THE INVENTION

It is an object of the present invention to provide a fast response temperature probe and an electronic thermometer having the same to overcome the disadvantages of the prior art.

The present invention discloses that the temperature probe precludes the unwanted heat flow from wires attached to a thermal sensor, or the wires are designed to reach an equilibrium temperature immediately. By experiments, this leads to reduction of time response up to 50%. To approach the equilibrium temperature instantly, the entire wires, or at least a portion of each wire, are preferably bonded to the inside of a thermal contact surface. In close contact with flesh in a body cavity, the thermal contact surface serves as a heater such that the wires come to the equilibrium temperature rapidly. Thus, the measurement time is dramatically reduced. Note that the wires are bonded using an insulating material with good thermal conductivity. Preferably, the wires are bonded to the inside of the thermal contact surface with epoxy resin.

According to the present invention, the above objects are resolved with a temperature probe. The temperature probe of the invention includes a probe body and a hollow tip member secured thereto. The hollow tip member has a thermal contact surface. A thermal sensor is mounted on the inside of the thermal contact surface of the hollow tip member. It senses the temperature of the thermal contact surface and produces a temperature signal. A set of wires is connected to the thermal sensor to pass the temperature signal. In particular, at least a portion of each wire is bonded to the inside of the thermal contact surface, thereby allowing the set of wires to reach thermal equilibrium.

According to another aspect of the invention, a thermometer with a temperature probe is disclosed. The thermometer includes an integrated and inseparable body member made up of a probe portion and a display portion. A hollow tip member having a thermal contact surface is secured to the probe portion. A thermal sensor is mounted on the inside of the thermal contact surface of the hollow tip member to sense the temperature of the thermal contact surface and produce a temperature signal. A set of wires is provided to connect the thermal sensor to display means. The wires are used to transfer the temperature signal from the sensor to the display means in which at least a portion of each wire is bonded to the inside of the thermal contact surface. The display means mounted on the display portion shows a corresponding temperature.

According yet another aspect of the invention, a thermometer with a temperature probe includes a separable body member made up of a probe body and a display body. A hollow tip member having a thermal contact surface is secured to the probe body. A thermal sensor is mounted on the inside of the thermal contact surface of the hollow tip member to sense the temperature of the thermal contact surface and produce a temperature signal. A set of wires is connected to the thermal sensor to pass the temperature signal, in which at least a portion of each wire is bonded to the inside of the thermal contact surface. A display, mounted on the display body, is attached to the thermal sensor through the set of wires for receiving the temperature signal and displaying a temperature corresponding to the received temperature signal.

### BRIEF DESCRIPTION OF THE DRAWINGS

The present invention will be described by way of exemplary embodiments, but not limitations, illustrated in the accompanying drawings in which like references denote similar elements, and in which:

FIG. 1 is a cross-sectional view of a conventional thermometer;

FIG. 2 is a diagram illustrating heat flows in the conventional thermometer of FIG. 1;

FIG. 3 is a cross-sectional view of a first embodiment according to the invention;

FIG. 4 is a cross-sectional view of a second embodiment according to the invention;

FIG. 5 is a cross-sectional view of a third embodiment according to the invention;

FIG. 6 is a diagram illustrating heat flows in the temperature probe of the invention; and

FIG. 7 is a diagram illustrating the wire connection in a hollow metal tip of the invention.

### DETAILED DESCRIPTION OF THE INVENTION

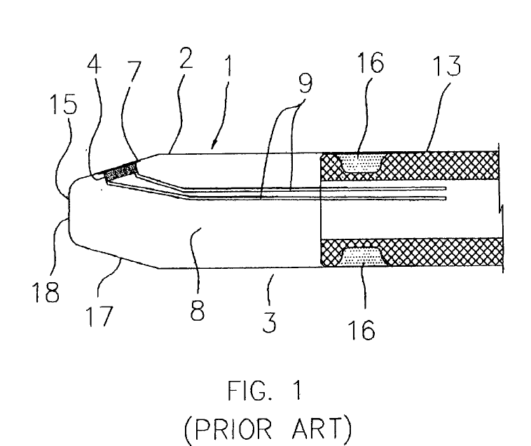

FIG. 1 illustrates a medical thermometer 1 according to a prior art. The thermometer 1 includes a metal tip 2 and a plastic probe body 13. The metal tip 2 is formed as a tubular part and attached to the plastic probe body 13 with glue 16. The metal tip 2 is made of thin metal and closed at the end 15. The end 15 has a conical portion 17 which is closed by a flat or rounded end portion 18. A temperature sensor 4 is mounted on the inner surface of the conical portion 17 by adhesive with good thermal conductivity. The remainder of the metal tip 2 is free from adhesive and preferably filled with air. Wires 9 connect the temperature sensor 4 to a circuit adapted to calculate and display the temperature measured by the sensor 4. The metal tip 2 also includes a contact surface 3 surrounding a hollow cavity S. The contact surface 3 is brought in contact with flesh of a patient.

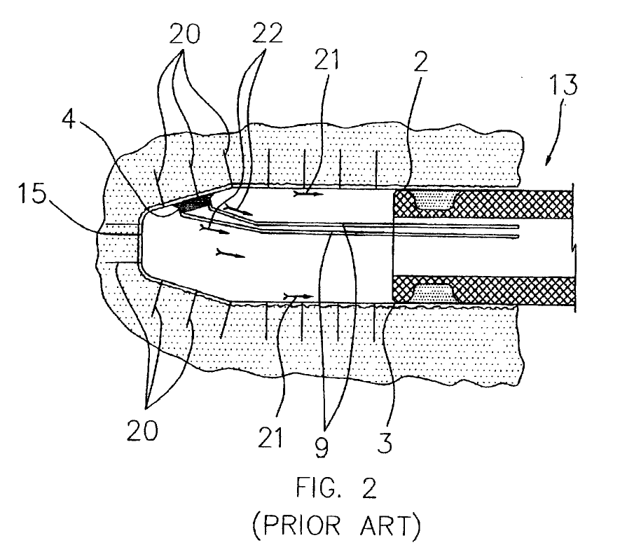

Referring to FIG. 2, the heat flow of the probe body 13 near the metal tip 2 is illustrated. Heat from the patient's flesh is transferred to the metal tip 2 as indicated by arrows 20. Meanwhile, heat flows through the metal tip 2 as shown by arrows 21 and also through the wires 9 as shown by arrows 22. The metal tip 2 is in contact with the patient's flesh over its entire length, the flesh surrounding the metal tip 2 functions like a distributing heater. Therefore, the heat flow 21 is very small and can be neglected. The metal tip 2 further serves as a thermal isolation between the end 15 of the metal tip 2 and the remaining part of the probe body 13.

The wires 9 without any treatment are exposed to the air within the metal tip 2, thus causing a considerable heat flow 22 that cannot be neglected. However, the prior art ignores this heat flow path intentionally. As a result, the thermometer 1 still takes a measurement time up to 30 seconds.

First Embodiment

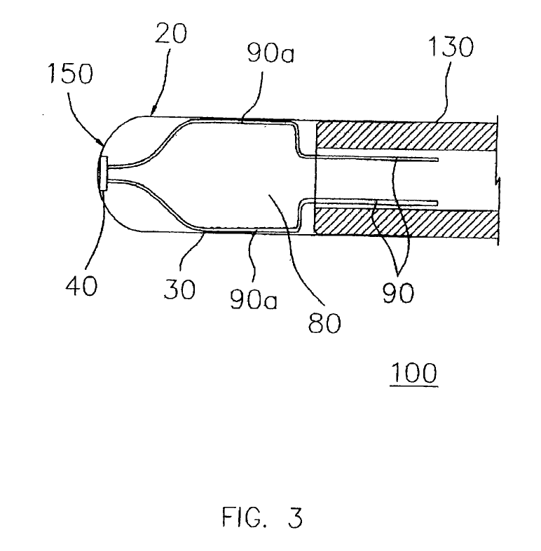

Referring to FIG. 3, a temperature probe 100 of the invention is illustrated. The temperature probe 100 includes a probe body 130 and a hollow tip member 20 secured to the probe body 130. The hollow tip member 20 has a thermal contact surface 30 surrounding a hollow cavity 80. A thermal sensor 40 is placed at the end 150 of the hollow tip member 20 and mounted on the inside of the thermal contact surface 30. The thermal sensor 40 senses the temperature of the thermal contact surface and produces a temperature signal. A set of wires 90 is connected to the thermal sensor to pass the temperature signal. Preferably, at least a portion of each wire is bonded to the inside of the thermal contact surface 30 as shown in FIG. 3.

Second Embodiment

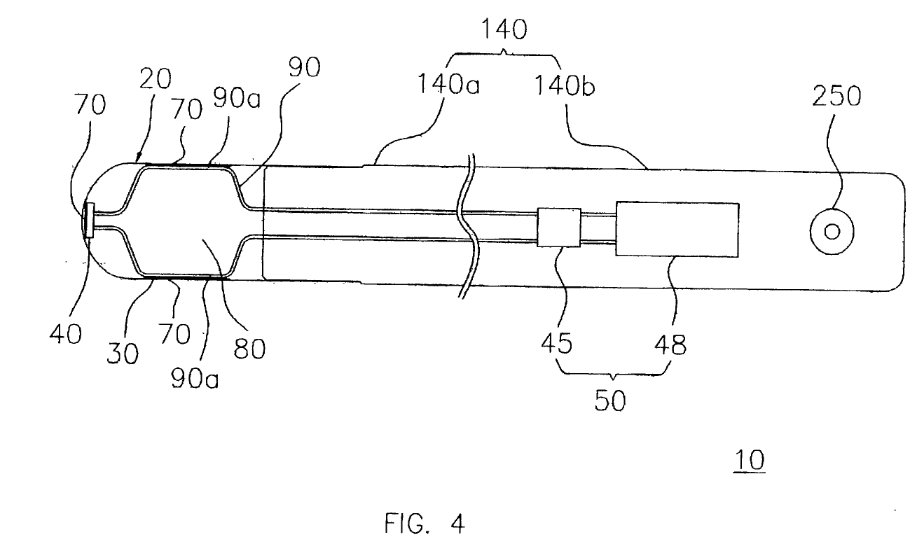

FIG. 4 is a thermometer 10 with a temperature probe according to the invention. The thermometer 10 includes an integrated and inseparable body member 140 plus a hollow tip member 20 in FIG. 4 the hollow tip member 20 is shown in an enlarged view for detailed description. The body member 140 is comprised of a probe portion 140a and a display portion 140b. The hollow tip member 20 having a thermal contact surface 30 is secured to the probe portion 140a, in which the thermal contact surface 30 surrounds a hollow cavity 80. A thermal sensor 40 is placed at the end 150 of the hollow tip member 20 and mounted on the inside of the thermal contact surface 30. The thermal sensor 40 senses the temperature of the thermal contact surface 30 and produces a temperature signal.

Display means 50 is mounted on the display portion 140b. A set of wires 90 is provided to connect the thermal sensor 40 to the display means 50. The wires 90 transfers the temperature signal from the sensor 40 to the display means 50. As depicted, at least a portion 90a of each wire is preferably bonded to the inside of the thermal contact surface 30. The display means 50 includes a display 48 and circuitry 45 coupled to the display 48. The circuitry 45 is connected to the wires 90 to receive the temperature signal. It drives the display 48 to show a temperature corresponding to the received temperature signal. The thermometer 10 also comprises a switch 250 to turn on and off the display means 50.

Third Embodiment

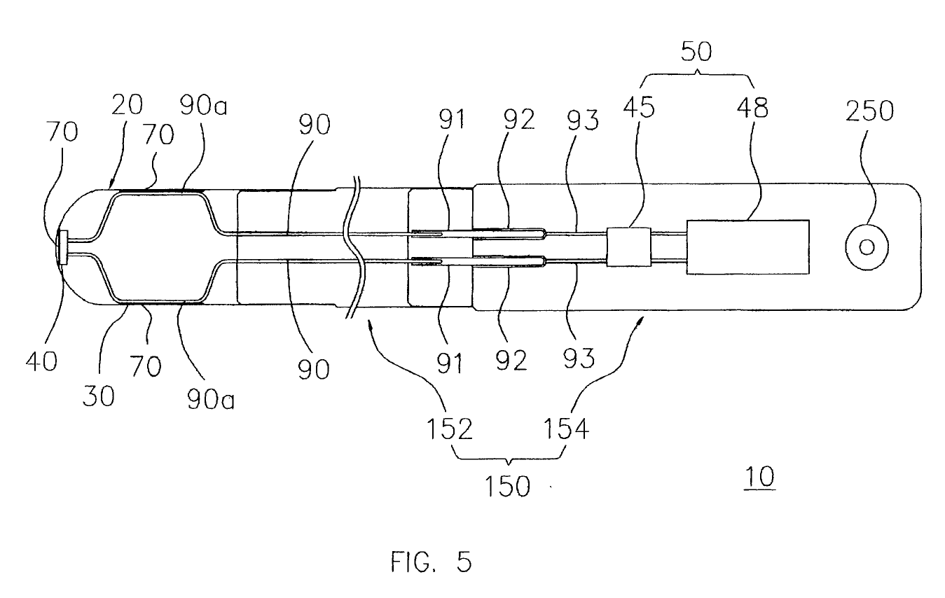

Turning now to FIG. 5, a thermometer 10 having a temperature probe is illustrated. The thermometer 10 includes a separable body member 150 and a hollow tip member 20. In FIG. 5 the hollow tip member 20 is shown in an enlarged view for detailed description. The body member 150 is made up of an independent probe body 152 and an independent display body 154. A hollow tip member 20 having a thermal contact surface 30 is secured to the probe body 152, in which the thermal contact surface 30 surrounds a hollow cavity 80. A thermal sensor 40 is placed at the end 150 of the hollow tip member 20 and mounted on the inside of the thermal contact surface 30. The thermal sensor 40 senses the temperature of the thermal contact surface 30 and produces a temperature signal. A set of wires 90 is connected to the thermal sensor 40 to pass the temperature signal. As depicted, at least a portion 90a of each wire is preferably bonded to the inside of the thermal contact surface 30.

Furthermore, the independent probe body 152 has a first connector 91 and the independent display body 154 has a second connector 92. The first connector 91 is attached to the wires 90. The second connector 92 is provided to connect to the first connector 91. Preferably, the first connector 91 is a male connector and the second connector 92 is a female connector to mate with the male connector 91. Display means 50, mounted on the independent display body 154, includes a display 48 and circuitry 45 coupled to the display 48. In the display body 154, wires 93 connect the female connector 92 to the circuitry 45. The circuitry 45 is attached to the thermal sensor 40 through the wires and the connectors to receive the temperature signal. It drives the display 48 to show a temperature corresponding to the received temperature signal. The thermometer 10 also comprises a switch 250 to turn on and off the display means 50.

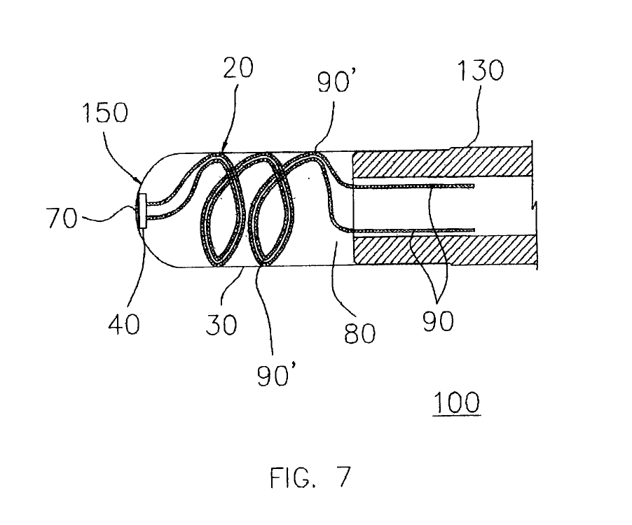

In the above-described embodiments, the hollow tip member 20 is preferably made of metal with high thermal conductivity, such as silver, platinum, or stainless steel. The hollow tip member 20 is made in the form of a tubular shape, and it has a domed, hemispherical or hemiellipsoid shaped end. Additionally, the preferred thermal sensor 40 is a thermistor. The wires 90 and the thermistor 40 are both adhered on the inside of the thermal contact surface 30 of the hollow tip member 20 with heat conductive glue 70. According to the invention, the glue 70 is an insulating material with good thermal conductivity, e.g., epoxy resin. Moreover, the wires 90 are made up of a pair of electrical lead wires. To enhance the conductive effect, optionally, wires 90′ are bonded to the inside of the thermal contact surface 30 in a spiral form as shown in FIG. 7. In this way, the thermistor and the wires can reach thermal equilibrium very quickly.

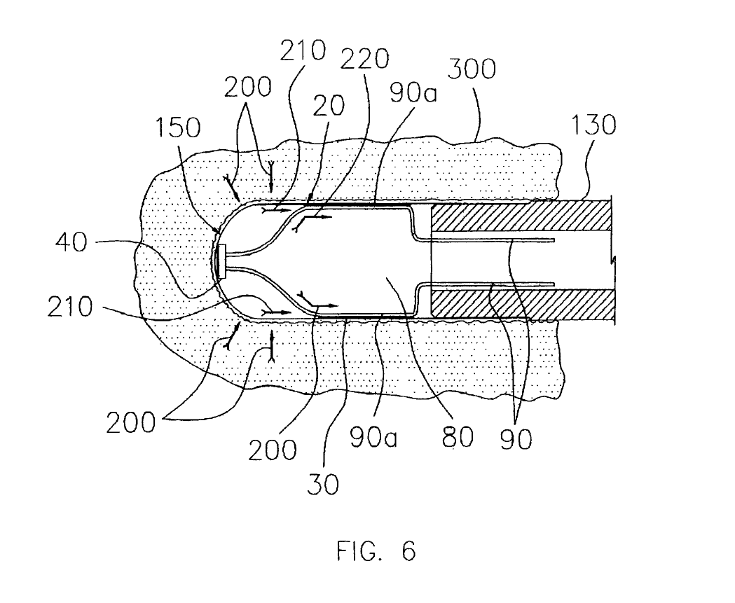

Referring now to FIG. 6, the heat flow of the probe body 130 near the hollow tip member 20 is illustrated. Heat from the patient's flesh is transferred to the hollow tip member 20 as indicated by arrows 200. In the mean time, heat flows through the hollow tip member 20 as shown by arrows 210 and also through the wires 9 as shown by arrows 220. The hollow tip member 20 is in close contact with the patient's flesh over its entire member, the flesh surrounding the hollow tip member 20 functions like a distributing heater. Consequently, the heat flow 210 is relatively small and can be neglected. The hollow tip member 20 further serves as a thermal isolation between the end 150 of the hollow tip member 20 and the probe body 130.

A key feature of the invention is that at least a portion of each wire is bonded to the inside of the thermal contact surface, which, in turn, precludes the unwanted heat flow from the wires attached to the thermal sensor. This allows the wires to approach an equilibrium temperature quickly as the thermal contact surface is heated, so that the thermal sensor reaches thermal equilibrium more rapidly and up to 50% of the measurement time is saved. Preferably, the wires in the hollow tip member are entirely bonded to the inside of the thermal contact surface in order to avoid exposure to the air within the hollow cavity. In this regard, the unwanted heat flow is minimized. Surrounded by the patient's flesh, the thermal contact surface serves as a heater so the wires come to the equilibrium temperature immediately. This effectively shortens the measurement time further.

TABLE 1 cites a calibration report of Taiwan Electronics Testing Center to demonstrate the effect of the invention. When inserted from the room temperature (23±2° C.) into a water tank with a temperature of 37° C., the thermometer of the invention only takes 5.81 seconds to obtain the accurate measurement. As set forth in TABLE 1 here, it significantly shortens more than 50% of the measurement time that is 12 seconds originally.

TABLE 1

| Circumstance | Relative | Target | Measurement |
|---|---|---|---|
| Temperature | Humidity | Temperature | Time |
| 23 ± 2 ° C. | 50 ± 10% | 37° C. | 5.81 sec. |

While the invention has been described by way of example and in terms of the preferred embodiments, it is to be understood that the invention is not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A temperature probe comprising:
a probe body;
a hollow tip member secured to the probe body and having a thermal contact surface;
a thermal sensor mounted on the inside of the thermal contact surface of the hollow tip member, for sensing the temperature of the thermal contact surface and producing a temperature signal; and
a set of wires connected to the thermal sensor for passing the temperature signal;
wherein at least a portion of each wire is bonded to the inside of the thermal contact surface, thereby allowing the set of wires to reach thermal equilibrium as the thermal contact surface is heated.

2. The temperature probe as recited in claim 1 wherein the hollow tip member is made of thermal conductivity metal.

3. The temperature probe as recited in claim 1 wherein the hollow tip member has a hollow cavity filled with air in which the wires in the hollow cavity are bonded to the inside of the thermal contact surface to avoid exposure to the air, thereby allowing the wires to reach thermal equilibrium quickly.

4. The temperature probe as recited in claim 1 wherein the hollow tip member is made of silver, platinum, or stainless steel.

5. The temperature probe as recited in claim 1 wherein the wires are made up of a pair of electrical lead wires.

6. The temperature probe as recited in claim 1 wherein the wires are bonded to the inside of the thermal contact surface by an insulating material with good thermal conductivity.

7. A thermometer with a temperature probe, comprising:
an integrated and inseparable body member including a probe portion and a display portion;
a hollow tip member secured to the probe portion and having a thermal contact surface;
a thermal sensor mounted on the inside of the thermal contact surface of the hollow tip member, for sensing the temperature of the thermal contact surface and producing a temperature signal;
a set of wires connected to the thermal sensor for passing the temperature signal, in which at least a portion of each wire is bonded to the inside of the thermal contact surface; and
display means, mounted on the display portion attached to the thermal sensor through the set of wires for receiving the temperature signal and displaying a temperature corresponding to the received temperature signal.

8. The thermometer as recited in claim 7 wherein the thermal sensor is a thermistor.

9. The thermometer as recited in claim 7 wherein the thermal sensor is mounted on the inside of the thermal contact surface of the hollow tip member by heat conductive glue.

10. The thermometer as recited in claim 7 wherein the wires are bonded to the inside of the thermal contact surface of the hollow tip member by an insulating material with thermal conductivity.

11. The thermometer as recited in claim 7 wherein the display means comprises a display and circuitry coupled to the display, in which the circuitry is connected to the wires to receive the temperature signal and drives the display to show the corresponding temperature.

12. The thermometer as recited in claim 7 further comprising a switch for turning on and off the display means.

13. A thermometer with a temperature probe, comprising:
a separable body member including a probe body and a display body;
a hollow tip member secured to the probe body and having a thermal contact surface;
a thermal sensor mounted on the inside of the thermal contact surface of the hollow tip member, for sensing the temperature of the thermal contact surface and producing a temperature signal;
a set of wires connected to the thermal sensor for passing the temperature signal, in which at least a portion of each wire is bonded to the inside of the thermal contact surface; and
a display, mounted on the display body, attached to the thermal sensor through the set of wires for receiving the temperature signal and displaying a temperature corresponding to the received temperature signal.

14. The thermometer as recited in claim 13 wherein the probe body comprises a first connector for attaching to the wires.

15. The thermometer as recited in claim 14 wherein the display body comprises a second connector for connecting to the first connector.

16. The thermometer as recited in claim 15 wherein the first connector is a male connector and the second connector is a female connector to mate with the male connector.
